(19) United States
(12) Patent Application Publication
(10) Pub. No.: US 2016/0026668 A1
(43) Pub. Date: Jan. 28, 2016

(54) DATA TRANSMISSION SERVICE SWITCH SYSTEM AND METHOD

(71) Applicant: Quanta Computer Inc., Kuei Shan Hsiang (TW)

(72) Inventors: Tien-Chin Fang, Kuei Shan Hsiang (TW); Chen-Chung Lee, Kuei Shan Hsiang (TW); Ping-Chi Lai, Kuei Shan Hsiang (TW); Chia-Hung Lin, Kuei Shan Hsiang (TW); Ming-Jen Chen, Kuei Shan Hsiang (TW); Ching-Wen Lin, Kuei Shan Hsiang (TW)

(21) Appl. No.: 14/565,704

(22) Filed: Dec. 10, 2014

(30) Foreign Application Priority Data
Jul. 22, 2014 (TW) 103125048

(51) Int. Cl. G06F 17/30; H04L 12/24

(52) U.S. Cl. CPC G06F 17/30345; H04L 41/082; G06F 17/30876

(57) ABSTRACT

A data transmission service switch system and method are provided. The data transmission service switch system includes user equipment and a server. The user equipment is configured to generate service request information, receive a pipe message and record a pipe time, wherein the service request information includes a plurality of service requests. The server has a database and is configured to generate a calculated result according to the service request information and stored information in the database. The server further transmits the pipe message according to service mechanisms corresponding to each of the service requests which are included in the calculated result. The server further adjusts the stored information of the database according to the pipe time.

### CROSS REFERENCE TO RELATED APPLICATIONS

This Application claims priority of Taiwan Patent Application No. 103125048, filed on Jul. 22, 2014, the entirety of which is incorporated by reference herein.

### BACKGROUND OF THE INVENTION

1. Field of the Invention

The disclosure is related to data transmission service switch technology, and, more particularly, to a method of dynamically adjusting the service mechanism corresponding to the service request.

2. Description of the Related Art

Recently, because of the rapid development of wireless communications, devices such as mobile phones, smartphones, personal digital assistants, and tablet PCs have become widely available, and have become more and more technically advanced and multifunctional. Due to the increased convenience and functionality of the devices, these devices have become necessities of life.

When a user uses these communication devices to execute application software (APP) or to execute an application with the internet browser, and a server is needed to provide service for him, the different service requests usually can only be transmitted by the fixed service mechanism (e.g. SignalR service mechanism, Restful service mechanism, Windows Communication Foundation (WCF) service mechanism, Web Service (W/S) mechanism, and so on) allocated by the server. Therefore, when the network environment changes or the service mechanism is broken, the server can't immediately switch to another service mechanism to provide service for the user. As a result, the service corresponding to the service request of the user will be affected.

### BRIEF SUMMARY OF THE INVENTION

A system and method of sleep detection are provided to overcome the problems mentioned above.

An embodiment of the invention provides a data transmission service switch system. The data transmission service switch system comprises user equipment and a server. The user equipment is configured to generate service request information, receive a pipe message and record a pipe time, wherein the service request information comprises a plurality of service requests. The server has a database and is configured to generate a calculated result according to the service request information and stored information of the database, transmit the pipe message according to service mechanisms corresponding to each of the service requests which are comprised in the calculated result, and adjust the stored information of the database according to the pipe time.

An embodiment of the invention provides a data transmission service switch method. The data transmission service switch method comprises the step of generating service request information by user equipment, wherein the service request information comprises a plurality of service requests. The data transmission service switch method further comprises the step of generating, by a server, a calculated result according to the service request information and stored information in a database. The data transmission service switch method further comprises the step of transmitting, by the server, a pipe message to the user equipment according to service mechanisms corresponding to each of the service requests which are comprised in the calculated result. The data transmission service switch method further comprises the step of receiving, by the user equipment, the pipe message and recording a pipe time and transmitting the pipe time to the server. The data transmission service switch method further comprises the step of adjusting, by the server, the stored information according to the pipe time.

Other aspects and features of the invention will become apparent to those with ordinary skill in the art upon review of the following descriptions of specific embodiments of communication transmission methods and systems

### BRIEF DESCRIPTION OF THE DRAWINGS

The invention will become more fully understood by referring to the following detailed description with reference to the accompanying drawings, wherein:

FIG. 1 is block diagram illustrating the data transmission service switch system 100 according to an embodiment of the invention;

FIG. 2 is block diagram illustrating the server 120 according to an embodiment of the invention;

FIG. 3 is a flowchart 300 of a data transmission service switch method according to an embodiment of the invention;

FIG. 4 is a flowchart 400 of step S320 according to an embodiment of the invention;

FIG. 5 is a flowchart 500 of a data transmission service switch method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

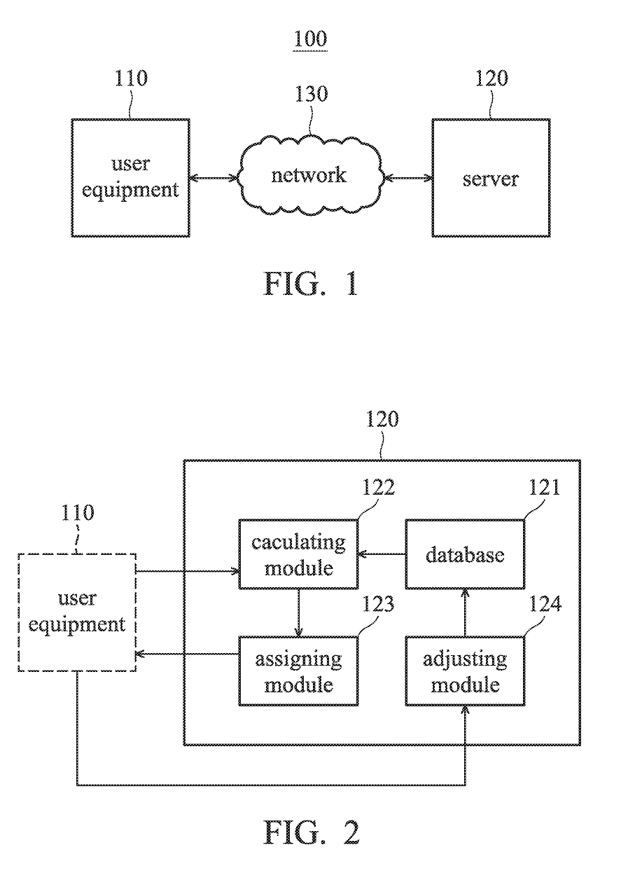

FIG. 1 is block diagram illustrating the data transmission service switch system 100 according to an embodiment of the invention. As shown in FIG. 1, the data transmission service switch system comprises user equipment 110, a server 120 and a network 130. The block diagram of FIG. 1 is only for specifying the embodiments of the invention, and it is to be understood that the invention is not limited thereto. The server 120 also communicates with a plurality of user equipment.

In an embodiment of the invention, the user equipment 110 is a mobile phone, a smartphone, a tablet, a Personal Communication Service (PCS) phone, a cordless phone, a Session Initiation Protocol (SIP) phone, a wireless local loop (WLL) station, a personal digital assistant (PDA), a portable device with wireless communication function, or a processing device connected with a wireless modem.

In an embodiment of the invention, the server 120 is a server or a network host which is configured to provide service for all user equipment in the client end by a network service manufacturer or an application (APP). The different service corresponding to different service requests form user equipment will be provided to user by the server 120.

In an embodiment of the invention, the network 130 can operate according to different wireless network access technologies, wherein the different wireless network access technologies comprise Long Term Evolution (LTE) technology, Code Division Multiple Access-2000 (CDMA 2000, e.g. 1× radio transmission technology (1×RTT), 1×EV-DO Release 0/A/B/C, 1×EV-DO Release D/E/F), WiMax, wireless local area network, Universal Mobile Telecommunications System (UMTS), and so on.

In an embodiment of the invention, when user equipment 110 is configured to execute application software (APP) or execute an application with the internet browser, and the server 130 is needed to provide service for it, the user equipment 110 will generate service request information and transmit the service request information to the server 120 through the network 130. In an embodiment of the invention, the service request information comprises the network environment status (e.g. link status, bandwidth) of the user equipment 110, a plurality of the service requests of the user equipment 110, and so on. For example, when the user equipment 110 executes one instant messaging application software, and needs to transmit a message to another user equipment, the user equipment 110 will generate a service request information corresponding to the operation of transmitting the message and transmit the service request information to the server 120. The service request information corresponding to the operation of transmitting the message may comprise the on-line service request, send-message service request, and acknowledgement (ACK) service request. This example is only one embodiment of the invention and it should be understood that the invention is not limited thereto. When executing different applications or operations, the service request information may comprise different service requests, such as when user equipment 110 needs to receive the message from another user equipment, the service requests corresponding to the operation of receiving the message may be different from the service requests corresponding to the operation of transmitting the message.

FIG. 2 is block diagram illustrating the server 120 according to an embodiment of the invention. As shown in FIG. 2, the server 120 comprises a database 121, a calculating module 122, an assigning module 123, and an adjusting module 124.

The calculating module 122 may calculate the data size corresponding to each service request according to the service request information and the stored information in the database 121 after the calculating module 122 received the service request information from the user equipment 110. Then, the calculating module 122 selects an appropriate service mechanism (e.g. SignalR service mechanism, Restful service mechanism, WCF service mechanism, W/S service mechanism, etc.) for different service requests by an algorithm to generate a calculated result. The calculating module 122 may transmit the calculated result to the assigning module 123 after generating the calculated result. The assigning module 123 will know the service mechanisms corresponding to different service requests according to the calculated result. Namely, the assigning module 123 may transmit data to user equipment 110 according to the service mechanisms corresponding to different service requests.

In an embodiment of the invention, the stored information in the database 121 comprises the time parameters and weighting values corresponding to each service mechanism, wherein the transmission rate of each service mechanism can be obtained according to the time parameters. Note that the database 122 may pre-set the time parameters and weighting values corresponding to each service mechanism. Therefore, when the calculating module 122 performs the first calculation, the calculating module 122 may calculate according to the pre-set time parameters and weighting values corresponding to each service mechanism. In the subsequent calculation, the calculating module 122 will calculate according to the adjusted stored-information.

In an embodiment of the invention, in the algorithm, the data size of each service request is multiplied by the time parameter of each service mechanism and divided by the weighting value of each service mechanism, and the service mechanism corresponding to the minimum value of the resulted result is selected as the service mechanism corresponding to the service request. For example, as shown in tables 1-4, when user equipment 110 executes an instant messaging application and needs to transmit a message to another user equipment, the service requests corresponding to the operation of transmitting the message may comprise service requests R1, R2 and R4 (as shown in table 1). Therefore, the calculating module needs to select the appropriate service mechanism corresponding to the service requests R1, R2 and R4. Table 1 shows the service requests which the instant messaging application may use. Tables 2 and 3 show the time parameters and weighting values corresponding to the service mechanisms C1-C4. Table 4 shows the calculated results calculated through the algorithm.

TABLE 1

| Service Request | Data Size |
|---|---|
| R1: on-line | 6 kb |
| R2: transmitting message | 36 kb |
| R3: receiving message | 50 kb |
| R4: ACK | 3 kb |
| R5: obtaining list | 100 kb |

TABLE 2

| | Time Parameter |
|---|---|
| Service Mechanism | (sec/1 kb) |
| C1: SignalR | 0.1 |
| C2: Restful | 0.3 |
| C3: WCF | 0.5 |
| C4: W/S | 0.7 |

TABLE 3

| Service | Weighting |
|---|---|
| Mechanism | Value |
| C1: SignalR | 4 |
| C2: Restful | 3 |
| C3: WCF | 2 |
| C4: W/S | 1 |

TABLE 4

| R1 | | R2 | | R3 | |
|---|---|---|---|---|---|
| (6 * 0.1)/4 | 0.15 | (36 * 0.1)/4 | 0.9 | (3 * 0.1)/4 | 0.075 |
| (6 * 0.3)/3 | 0.6 | (36 * 0.3)/3 | 3.6 | (3 * 0.3)/3 | 0.3 |
| (6 * 0.5)/2 | 2.1 | (36 * 0.5)/2 | 12.6 | (3 * 0.5)/2 | 1.05 |
| (6 * 0.7)/1 | 3 | (36 * 0.7)/1 | 18 | (3 * 0.7)/1 | 1.5 |

The calculating module 122 will select the minimum value from the calculated results as the service mechanisms corresponding to the service request R1, R2 and R4 after calculating the calculated results (as shown in Table 4) by the algorithm. In addition, note that the embodiment only describes the service mechanisms C1-C4, and it is should understood that the invention is not limited thereto. In other embodiments, other service mechanisms may be used. In addition, because the embodiment uses the initial calculation of calculating module 122 as an example, each service request corresponds to the same time parameter (default value) and weighting value (default value) of the service mechanisms as shown in tables 2 and 3. However, after the stored information has been adjusted by the adjusting module 124, each service request may be corresponded to different time parameter and weighting value of each of the service mechanisms. Namely, each service request may have its corresponding time parameter and weighting value of the service mechanisms to calculate different calculated results after the stored information has been adjusted by the adjusting module 124.

The assigning module 123 will transmit the pipe message to the user equipment 110 according to the service mechanisms corresponding to different service requests after obtaining the calculated results, wherein each pipe message comprises assigning data corresponding to a different service request. The user equipment 110 may display the related information in a display interface (not shown in figures) according to the pipe message after receiving the pipe message, wherein the related information displayed in the user equipment 110 may be a scene or a notification about the message that has been transmitted, or about whether the transmitted message has been read or not.

In addition, the user equipment 110 may record a pipe time according to the pipe message, wherein the pipe time is the time which the server 120 spent on corresponding to each service request of the user equipment 110. The user equipment 110 may transmit the pipe time to the adjusting module 124 of the server 120 after recording the pipe time. The adjusting module 124 may adjust the stored information in the database 121, such as adjusting the time parameters corresponding to the service mechanism, according to the pipe time after receiving the pipe time for the subsequent calculation of the calculating module 122. When the calculating module 122 receives the subsequent service request information from the user equipment 110, the calculating module 122 will generate a new calculated result according to this service request information and the adjusted stored-information to determine whether switches the service mechanism corresponding to each service request. Then the assigning module 123 may transmit the pipe message to the user equipment 110 according to the switched service mechanism of the new calculated result.

In an embodiment of the invention, the calculating module 110 may adjust the weighting value of the service mechanism according to the number of calls of the service mechanism during a time interval (e.g. 1 sec). For example, when the number of calls of the service mechanism during the time interval is more than 10 times, the calculating module 110 may decrease the weighting value of the service mechanism by 0.5.

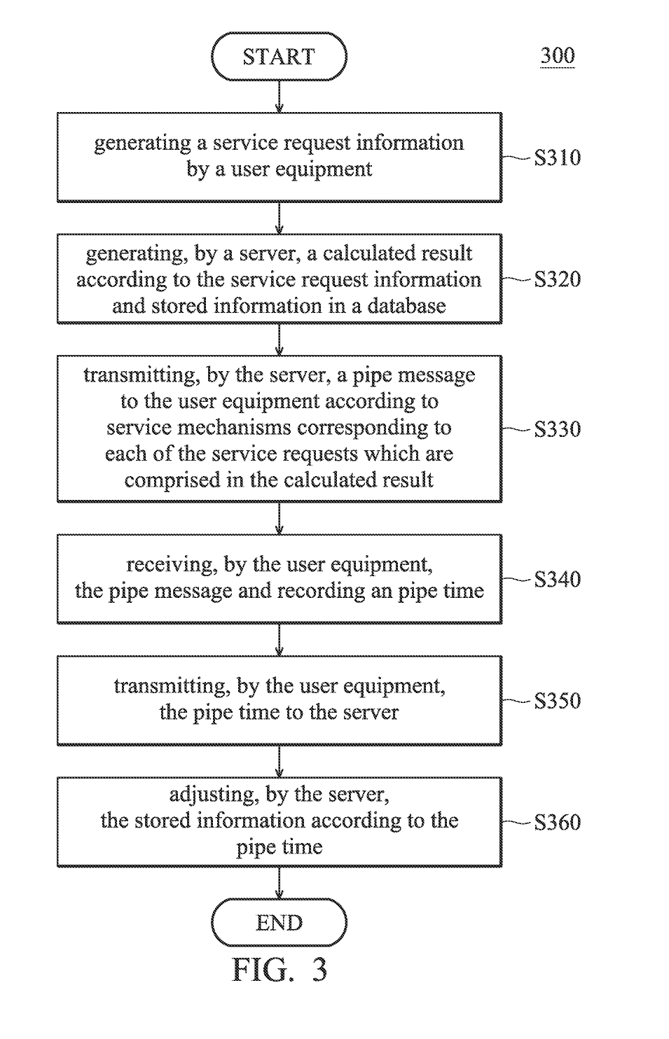

FIG. 3 is a flowchart 300 of a data transmission service switch method according to an embodiment of the invention. The method may be applied to the data transmission service switch system 100. As shown in FIG. 3, in step S310, a service request information is generated by the user equipment 110, and transmitted to the server 120, wherein the service request information comprises the network environment status (e.g. link status, bandwidth) of the user equipment 110, a plurality of service requests from the user equipment 110, and so on. In step S320, a calculated result is generated according to the service request information and the stored information in the database 121 by the server 120, wherein the stored information in the database 121 comprises the time parameters and weighting values corresponding to different service mechanisms. In step S330, the service mechanism corresponding to the service request may be known according to the calculated result, and the pipe message will be transmitted to the user equipment 110 according to the service mechanism corresponding to the service request. In step S340, the pipe message is received by the user equipment 110 and a pipe time is recoded. In step S350, the pipe time is transmitted to the server 120. In step S360, the stored information of the database 121 is adjusted according to the pipe time.

In an embodiment of the invention, the flowchart 300 further comprises adjusting the weighting value of the service mechanism according to the number of calls of the service mechanism during a time interval.

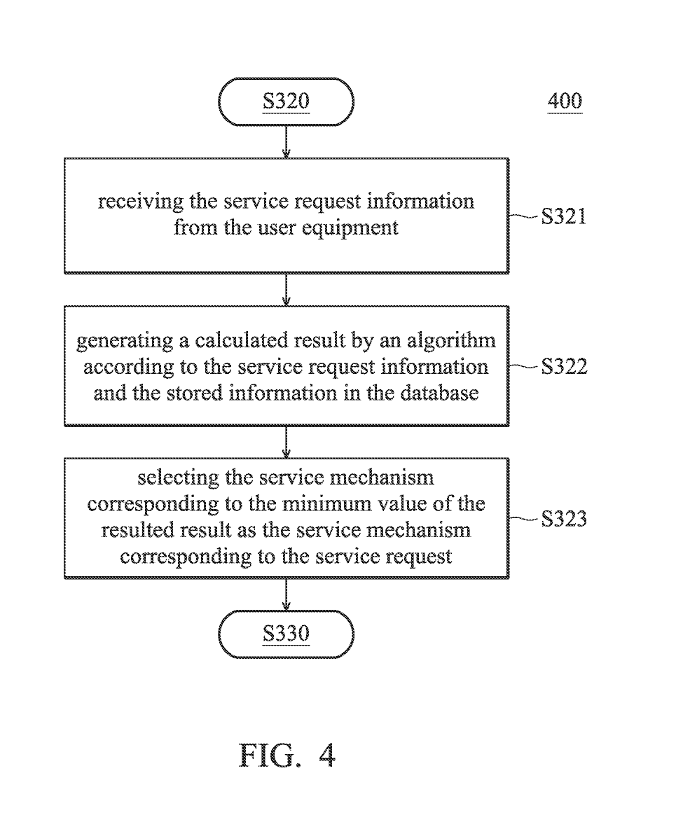

FIG. 4 is a flowchart 400 of step S320 according to an embodiment of the invention. As shown in FIG. 4, in step S321, the service request information is received from the user equipment 110, and the data size corresponding to each service request is calculated. In step S322, a calculated result is generated by an algorithm according to the service request information and the stored information in the database 121. In step S323, the service mechanism corresponding to the minimum value of the resulted result is selected as the service mechanism corresponding to the service request.

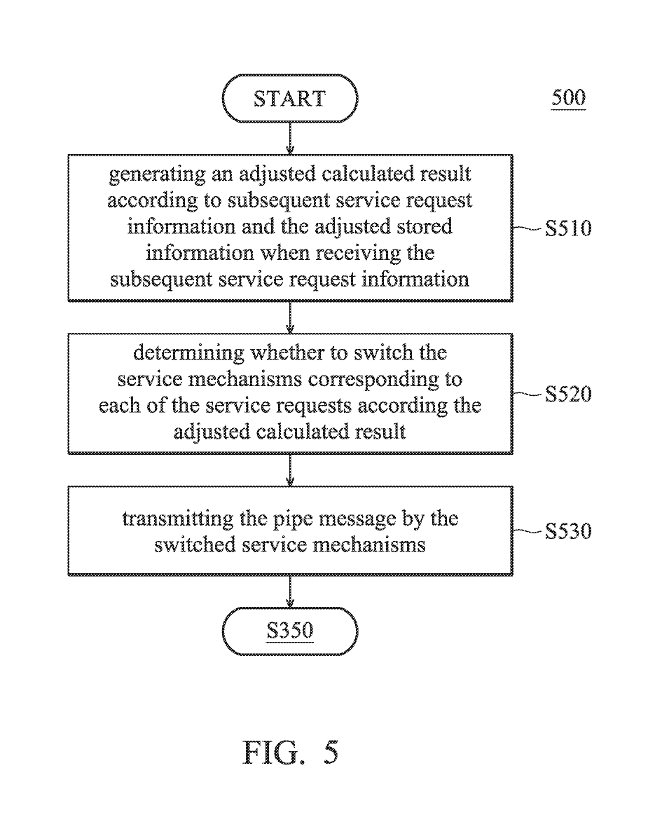

FIG. 5 is a flowchart 500 of a data transmission service switch method according to another embodiment of the invention, wherein the steps of the flowchart 500 can be regarded as the following steps of the flowchart 300. In step S510, when the subsequent service request information is received, an adjusted calculated result is generated according to the subsequent service request information and adjusted stored-information. In step S520, the service mechanism corresponding to the service request is determined to whether switched according the adjusted calculated result. In step S530, the pipe message is transmitted to the user equipment 110 according to the switched service mechanism. After step S530, the steps of flowchart 500 will come back to steps S350 and S360. If new service request information is received again, the steps of flowchart 500 will be reprocessed.

In traditional method, different service requests can only be transmitted by fixed service mechanism allocated by the server. Therefore, if the network environment changes or the service mechanism is broken, the server can't immediately switch to another better service mechanism to provide service for the user. As a result, the service corresponding to the service request of the user will be affected. Compared with traditional method, the data transmission service switch method of the invention ensures that the server can dynamically select the appropriate service mechanism corresponding to each service request according to the current network environment and the status of each service mechanism. Therefore, the efficiency and quality of transmission will be increased.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

Reference throughout this specification to “one embodiment” or “an embodiment” means that a particular feature, structure, or characteristic described in connection with the embodiment is included in at least one embodiment of the invention, but does not denote that they are present in every embodiment. Thus, the appearance of the phrases “in one embodiment” or “in an embodiment” in various places throughout this specification are not necessarily referring to the same embodiment of the invention.

The above paragraphs describe many aspects of the invention. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data transmission service switch system, comprising:
a user equipment, configured to generate a service request information, receive a pipe message and record a pipe time, wherein the service request information comprises a plurality of service requests; and
a server, having a database and configured to generate a calculated result according to the service request information and a stored information of the database, transmit the pipe message according to service mechanisms corresponding to each of the service requests which are comprised in the calculated result, and adjust the stored information of the database according to the pipe time.

2. The data transmission service switch system of claim 1, wherein the service request information comprises a time parameter and a weighting value corresponding to each of the service mechanisms.

3. The data transmission service switch system of claim 2, wherein the server comprises:
a calculating module, configured to receive the service request information from the user equipment, calculate a data size of each of the service requests according to the service request information and the stored information, and generate the calculated result according to an algorithm;
an assigning module, configured to transmit the pipe message to the user equipment according to the service mechanisms corresponding to each of the service requests which are comprised in the calculated result; and
an adjusting module, configured to receive the pipe time transmitted by the user equipment and adjust the stored information according to the pipe time.

4. The data transmission service switch system of claim 3, wherein when the calculating module receives a subsequent service request information, the calculating module generates an adjusted calculated result according to the subsequent service request information and the adjusted stored-information to determine whether to switch the service mechanisms corresponding to each of the service requests.

5. The data transmission service switch system of claim 4, wherein the assigning module transmits the pipe message by the switched service mechanisms according to the adjusted calculated result.

6. The data transmission service switch system of claim 3, wherein the calculating module adjusts the weighting value of the service mechanism according to the number of calls of the service mechanism during a time interval.

7. A data transmission service switch method, comprising:
generating a service request information by a user equipment, wherein the service request information comprises a plurality of service requests;
generating, by a server, a calculated result according to the service request information and stored information in a database;
transmitting, by the server, a pipe message to the user equipment according to service mechanisms corresponding to each of the service requests which are comprised in the calculated result;
receiving, by the user equipment, the pipe message and recording an pipe time;
transmitting, by the user equipment, the pipe time to the server; and
adjusting, by the server, the stored information according to the pipe time.

8. The data transmission service switch method of claim 7, wherein the service request information comprises a time parameter and a weighting value corresponding to each of the service mechanisms.

9. The data transmission service switch method of claim 8, further comprising:
receiving the service request information from the user equipment;
calculating a data size of each of the service request according to the service request information and the stored information; and
generating the resulted result according to an algorithm.

10. The data transmission service switch method of claim 9, further comprising:
generating an adjusted calculated result according to subsequent service request information and the adjusted stored information when receiving the subsequent service request information to determine whether to switch the service mechanisms corresponding to each of the service requests.

11. The data transmission service switch method of claim 10, further comprising:
transmitting the pipe message by the switched service mechanisms according to the adjusted calculated result.

12. The data transmission service switch method of claim 9, further comprising:
adjusting the weighting value of the service mechanism according to the number of calls of the service mechanism during a time interval.
